(19) United States
(12) Patent Application Publication
(10) Pub. No.: US 2026/0369061 A1
(43) Pub. Date: Nov. 19, 2026

(54) INTELLIGENT SCENE SUMMARIES FOR MEDIA CONTENT

(71) Applicant: DISH Network L.L.C., Englewood, CO (US)

(72) Inventor: Sanket Rege, Englewood, CO (US)

(73) Assignee: DISH Network L.L.C., Englewood, CO (US)

(21) Appl. No.: 19/207,803

(22) Filed: May 14, 2025

(51) Int. Cl. G06V 20/40; G06V 20/70; H04N 21/472; H04N 21/4722

(52) U.S. Cl. CPC G06V 20/47; G06V 20/70; H04N 21/47217; H04N 21/4722

(57) ABSTRACT

An automated process for generating scene summaries includes retrieving program data related to currently playing content and pausing the currently playing content in response to a request for a scene summary. The program data includes program text with associated playback timestamps. A summary window of the currently playing content is identified and may include a begin time and an end time. The process includes analyzing a subset of the program data having the associated timestamps at least partially in the summary window, where an artificial intelligence model generates the scene summary related to the currently playing content based on the subset of the program data. The scene summary of the currently playing content can be overlaid on the currently playing content. Other embodiments include corresponding computer systems, apparatus, processes, and computer program products recorded on one or more computer storage devices, each configured to perform the actions of the method.

### TECHNICAL FIELD

The following generally relates to automated generation of content summaries related to television programs, movies, or other media content. Some implementations may make use of artificial intelligence (AI) constructs, as described herein.

### BACKGROUND

Media consumption has undergone a remarkable evolution in recent years, transitioning from a collective family activity centered around the living room television set to a highly personalized experience that can be enjoyed across a multitude of devices and settings. In the bygone era, viewers were bound to programming schedules and limited media distribution, thereby constraining their television and movie watching to specific times and places. Now, with the proliferation of advanced streaming services and portable devices such as smartphones, tablets, and laptops, individuals have the freedom to access a diverse range of media content anytime and anywhere.

The shift to on-demand viewing liberates users from the constraints of traditional broadcasting schedules and geographic limitations, offering unprecedented convenience and choice. The modern landscape of media consumption, bolstered by technologies like digital video recorders and streaming media, caters to the individual's preferences and provides a tailored viewing experience. This has made an extensive library of content more accessible than ever, eliminating the barriers of space and time that once limited viewing opportunities. For example, live content such as sporting events can now be streamed without using traditional satellite or cable television services. The breadth of accessible video content and the increasing number of distractions can cause viewers to miss out on some details, meaning, or plot lines in video content.

For example, a family can be watching a movie when a child asks, “what is going on mom?” More broadly, viewers can sometimes develop a particular interest in a portion of a program or event. For example, a user may miss a point of dialogue in a program, or may be confused about symbolism in a scene, or may lose the plot in a scene. Similarly, viewers can get distracted while viewing a program, or can be unclear on what is happening during a program. Users currently do not have a tool to improve understanding of a scene.

### BRIEF SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes an automated process for generating scene summaries. The automated process also includes retrieving program data related to currently playing content and pausing the currently playing content in response to a request for a scene summary, where the program data includes program text with associated playback timestamps. A summary window of the currently playing content is identified and may include a begin time and an end time. The example process includes analyzing a subset of the program data having the associated timestamps at least partially in the summary window, where an artificial intelligence (AI) model generates the scene summary related to the currently playing content based on the subset of the program data. The scene summary of the currently playing content can be overlaid on the currently playing content. Other embodiments of this aspect include corresponding computer systems, apparatus, processes, and computer program products recorded on one or more computer storage devices, each configured to perform the actions of the methods.

Implementations may include one or more of the following features. The automated process where a portion of the scene summary may include a link to portions of the currently playing program used to generate the portion of the scene summary. The automated process may include playing back the portions of the currently playing program in response to receiving a command executing the link. The automated process may include presenting the scene summary to a viewer through a text-based message or an email. The scene summary may include data retrieved from a website in response to the request for the scene summary inquiring for analysis of a scene. The automated process may include resuming playback in response to a timeout duration passing while the scene summary is overlaid on the currently playing program. The automated process may include converting the request for the scene summary from voice to text. The automated process may include reformatting the converted request for the scene summary to include the begin time of the summary window and the end time of the summary window for submission to a large language model. Implementations of the described techniques may include hardware, a method or process, or computer software on a computer-accessible medium. Additional embodiments may include other systems, devices, computing systems, and automated processes similar to those described herein.

### BRIEF DESCRIPTION OF THE DRAWINGS

FIG. 1 illustrates an example data processing system for automated generation and distribution of summaries relating to media programs, in accordance with various embodiments.

FIG. 2 illustrates an example display including scene summary parameters, in accordance with various embodiments.

FIG. 3 illustrates an example display including a scene summary window, in accordance with various embodiments.

FIG. 4 illustrates an example process for delivering scene summaries, in accordance with various embodiments.

### DETAILED DESCRIPTION

The following detailed description is intended to provide several examples that will illustrate the broader concepts that are set forth herein, but it is not intended to limit the invention or the application and uses of the invention. Furthermore, there is no intention to be bound by any theory presented in the preceding background or the following detailed description. The detailed description refers to the accompanying drawings, which show such embodiments by way of illustration. While these embodiments are described in sufficient detail to enable those skilled in the art to practice the inventions, it should be understood that other embodiments may be realized, and that logical and mechanical changes may be made without departing from the spirit and scope of the inventions. The detailed description herein is thus presented for purposes of illustration only and not of limitation. For example, the steps recited in any of the method or process descriptions may be executed in any order and are not necessarily limited to the order presented.

According to various embodiments, the media viewing experience can be greatly improved by providing automatically-generated scene summaries in real time. These scene summaries can include text summaries or explanations of scenes to improve user understanding of a recently viewed scene or a scene currently playing.

In some embodiments, facial recognition, visual recognition, or other object recognition techniques may be used to identify the characters or other objects in a given scene. Audio levels or an audio signal can also be used for scene detection or emotional detection. For example, a sports commentator getting excited or increased crowd noise may indicate a major scene/play of interest. Audio signals can be analyzed to identify scenes of interest.

Scene summaries may also be based on social media, traditional media, web-based media, or other sources that identify clips of content, quote content, summarize content, or otherwise relate to or reference media content. The summary generation engine can access closed caption data, voice to text data, scene recognition data, social media data, web data, user viewing data, closed-loop data, the content itself, or other data related to a particular piece of content to summarize a scene of interest. For example, a request for a scene summary can inquire about analysis of the scene, for example, symbolism, character development, themes, motifs, staff names, context, or other forms of higher-level analysis performed on video content.

Summaries can be presented on displays, sent as a message, read aloud using a text-to-voice conversion. In some examples, content summaries can be presented on a “second screen” or other companion device such as a phone, tablet, computer, or other web-browsing device, as the viewer is watching the program, browsing programs, or at another time.

Some examples of scene summaries can be focused on particular individuals. For example, scene summaries can be generated for specific characters of a program. For example, a character may be absent from a series for several episodes, and a viewer may want a summary of the character’s past scenes of interest. In another example, scene summaries can be made to follow a particular sports player to generate text-based summaries of the player’s highlights, plays of interest, or other activity.

Scene summaries can be generated in any manner. In various embodiments, a locally-executing or remotely-available artificial intelligence (AI) agent can be prompted with a voice query or natural language query to generate relevant scene summaries. The AI agent may be trained on metadata about media programs, if desired, including actual program content (e.g., timed text, audio and/or video content). The AI agent may obtain information about the identified program from public or private databases, crowdsourced data, social media, closed-loop viewing data, or other sources. Scene summaries can be generated in response to a request or query. By providing relevant and timely scene summaries, the scene summary system can enhance the understanding enjoyment of a viewing experience.

Various embodiments make use of large language models (LLMs) or similar generative AI constructs. The artificial intelligence capabilities may be executed by a server system associated with a content provider, by a viewer-associated device (e.g., a phone, tablet, computer, or set-top box), or by a network service accessible to the content provider and/or the playback device.

In some implementations, the trained AI will receive a natural language query or a voice query that is unique to the relevant program (e.g., “Summarize the plot points in program X through the current playback position,” or “What is the symbolism of the goat in this scene?”). The natural language queries may be further enhanced with viewer information (e.g., “Summarize the actions of Character X in the current episode up to now without spoiling major plot points”), or with details about the program (e.g., “summarize the past 5 minutes of playback”). Other embodiments may generate more sophisticated queries using any number of factors.

In some examples, the AI system can be trained on user data as well. AI systems trained on past user history and subsequent viewing habits and selections can assess scenes that are confusing or often summarized based on important to future scenes, important to sequels, important sporting moments, important to other episodes, frequently replayed, skipped, seek points, or other potentially confusing locations in content based on viewing habits. The AI system trained on viewing histories of users or demographic groups of users can also generate content summaries that tend to be more appealing or digestible to the current user when using the current user’s demographics as an input. The AI system can compare the user’s current viewing traits or viewing activities to the user’s past history to make relevant and tailored scene summaries in some embodiments. The AI system can compare the user’s current traits or viewing activities to histories of other groups of users that have had similar viewing traits and activities to identify future confusion locations or other common scene summary triggers relevant to groups of users.

The AI techniques described herein may thus generate scene summaries of certain video content. The AI engine can assess which sections for which viewers more often request summaries more frequently by analyzing large quantities of content watching history. The AI engines of the present disclosure can also from external sources in some examples to determine which portions of content should be included in a particular summary. The AI engine can also consider closed captioning data or scripts for the content as a text-based input for summarizing scenes in the content.

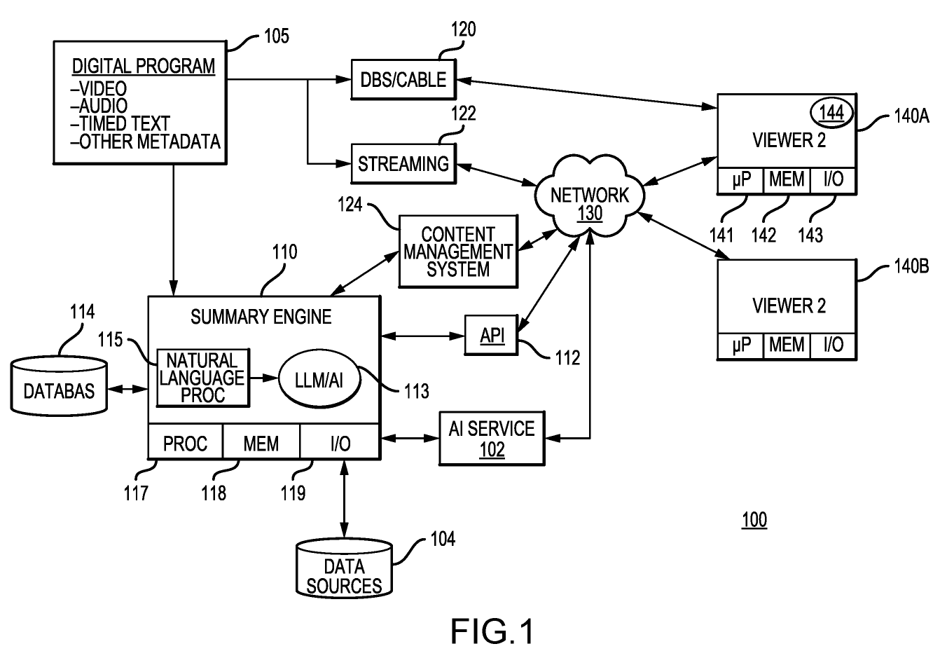

Turning now to the figures and with initial reference to FIG. 1, an example system 100 for generating scene summaries is shown, in accordance with various embodiments. System 100 may include a summary generation engine 110 (SGE) that formats queries based upon information regarding a media program or a user to arrive at machine-generated scene summary. The queries can pass inputs as arguments into a function in embodiments using a compatible AI engine such as, for example, generative adversarial networks (GAN). Video processing AI models similar to the SORA product offered by Open AI can be used in some examples, though a preferable video processing engine would take as input video and return as output text. LLM-based AI engines can accept text queries formatted as sentences. Voice queries can be converted to text and fed into text-based LLM models in some embodiments. In some examples, voice-to-text conversions can be used on media content itself or on a voice request for a scene summary. Any type of AI engine and/or combinations of AI models can be used, and appropriate queries or inputs can be formulated by system 100 to pass as inputs metadata regarding a user and a selected scene. Automatically-generated summaries may be delivered to any number of media viewer devices 140A-B via a content management system (CMS) 124, via an application program interface (API) 112, or with the content itself as desired.

Scene summaries can be generated in any manner, based upon any available information about the particular media program selected for viewing or in playback. In various embodiments, a generative AI model 113 (or a similar AI construct, such as a machine learning system, neural network, deep learning system, predictive AI system, or other AI constructs suitable for generating summaries) executes within the SGE 110 to process queries that result in text-based scene summaries. Alternatively, SGE 110 formats natural language queries or argument-based queries that can be posited to commercial LLMs, commercial databases, public databases, or other data sources 104 via the Internet or another network 130. Queries for AI model 113 and any resultant summaries or responses received from AI model 113 can be stored in a database 114 for subsequent retrieval or further processing, if desired. In some examples, summaries can be pre-processed and generated as generic summaries that can then be stored in association with the summarized content. Generic summaries stored with the summarized scenes can be retrieved nearly instantaneously in response to a user initiating a request for the summaries, as AI model 113 has already generated the generic summaries in some embodiments.

Video content 105 may be received and delivered in any manner. Video content 105 may also be referred to herein as a program, content, media, or other related terms. In various embodiments, video content 105 is received via network 130, terrestrial broadcast, satellite broadcast, or in any other suitable manner. Video content 105 may include a multiplex of digital streams that are synchronized in time to represent a particular television program, movie, or other media program. An MPEG multiplex, for example, typically represents a media program with one or more video streams, one or more audio streams, one or more timed text streams, and associated metadata that encodes the content of the particular content 105. Generally speaking, the various component streams of the multiplex can be synchronized by common timing data, such as a presentation time stamp (PTS), so that content from the various video, audio, and timed text streams can be presented in synchrony to the viewer.

In some implementations, system 100 delivers video content 105 to the various viewer devices 140A-B for playback. Such viewer devices may also be referred to herein as playback devices, media viewer devices, set-top boxes, place-shifting devices, sat-back boxes, viewer devices, and/or hardware devices. FIG. 1 illustrates a digital broadcast satellite (DBS) or cable connection 120 that provides a broadcast of the content, along with a video streaming system 122 that provides an over the top (OTT), IPTV, or other type of video stream. Although FIG. 1 illustrates both broadcast and streaming media delivery services, various embodiments of system 100 might include both, either, or some other distribution scheme. Other embodiments could deliver content 105 via any third-party or other broadcast or streaming services, as desired. Further, it is possible to deliver scene summaries separate from the content. The generated scene summaries can be delivered by system 100 by components separate from the delivery of the underlying content 105, in accordance with various embodiments.

Viewers can enjoy their media program content and receive machine-generated scene summaries in any manner. In the example of FIG. 1, viewers make use of hardware devices 140A-B such as set-top boxes (STBs), smart televisions, video streaming devices, personal computers, mobile phones, tablets, or the like. Different viewers may make use of different types of devices 140A-B, each having computing hardware such as a processor 141, memory or other non-transitory digital storage 142, and suitable input-output interfaces 143, as desired. In the example of FIG. 1, the viewer controls his or her device 140A to select and view media content 105, to pose queries or make scene summary requests, to receive summaries from system 100, to with the summaries, and to respond to system 100 via API 112 on network 130. For example, a user may pose a query using a microphone, keyboard, remote, touch screen, or other types of input devices part of and/or in communication with a device 140A. Other embodiments could split the media viewing and summary-generation processes across two or more devices 140, if desired. A viewer may watch content 105 on a regular television set, for example, while simultaneously interacting with the scene summaries on a tablet, phone or personal computer.

Hardware devices 140A-B can include a content buffer used during playback to buffer content. The playback buffer can store recently viewed content for a limited duration. For example, the playback buffer can store recently played content for 3 minutes, 5 minutes, 10 minutes, 15 minutes, or any other desirable duration within the capabilities of system memory. The buffered data can be more quickly analyzed in response to a scene summary request than memory stored on permanent storage.

SGE 110 may operate in any manner. In the example of FIG. 1, SGE 110 and other computer-based systems described herein may execute firmware or software on conventional computing hardware such as one or more processors 117, memory or other non-transitory digital storage 118, and any appropriate input/output interfaces 119. A non-tangible computer-readable medium of computing devices described herein can be configured to store instructions thereon that, when executed by the computing devices, cause the devices to perform operations. Equivalent embodiments may make use of cloud-based computing resources such as the virtual machine architectures provided by Amazon Web Services (AWS), Microsoft Azure, Google Cloud, IBM Cloud, or the like. SGE 110 is depicted in the example of FIG. 1 as logically separate from viewer devices 140A-B. SGE 110 can also be integrated into viewing devices 140A-140B, content management system 124, or any of the various computing device in communication with network 130. In some examples, SGE 110 can execute on cloud computing infrastructure, on traditional servers, on computing clusters, locally on playback devices 140A-B, on combinations of different hardware, or on any suitable computing hardware.

SGE 110 processes available data or interacts with other services to generate the scene summaries referenced herein. In one example, SGE 110 supports an LLM, GAN, or other type of AI model 113 that is trained upon data relating to media content 105, user viewing histories, use groupings, or other relevant data. The data may include actual program content, such as the audio content or the timed text content, as appropriate. Audio content may be analyzed after performing a speech-to-text conversion, as desired. In some embodiments, verbal audio can be analyzed using a script or using closed captioning data. Similarly, video content may be analyzed using a computer vision tool to analyze visual elements that can add understanding to the context (e.g., scene changes, key actions) if desired. Examples of such tools could include the Open Computer Vision Library (OpenCV), the TensorFlow tools available from Google Inc., or any number of other tools desired.

In many implementations, the timed text stream of content 105 will provide closed captioned program contents, along with convenient timing information from the presentation time stamps or other timing data. The text may be analyzed to recognize characters, scenes, and other attributes of the media program. AI model 113 may be additionally or alternately trained on additional metadata, or information about the program, that is available from data sources 104, such as any public database (e.g., Wikipedia), private database (e.g., the GRACENOTE media database service available from Gracenote, Inc. of Emeryville, California or the IMDB service maintained by Amazon Inc. of Seattle, Washington), user data, past interaction (e.g., rewind, skip, or pause) data, social media, traditional media, review sites, or the like. The trained model can generate scene summaries emphasizing portions of the content likely important to the viewer or likely of interest to the viewer.

In some implementations, metadata, program content, or any other data used to train the model may be provided to an AI framework that converts the received data to mathematical vectors that can be stored in a database for further processing and retrieval. Vectors may be stored in database 114, if desired, or in a separate database that is formatted for use by AI 113. After training, AI 113 may be configured to identify moments for inclusion in content summaries and generate a text-based scene summary.

Network AI services 102 could also be used to obtain content, supplementary data, or otherwise assist in generating summaries. Examples of current AI services 102 may include the ChatGPT service available from OpenAI, the Bard service available from Google, the MetaAI service available from Meta Inc., or the Watson service available from IBM Corp. Additional AI services are being deployed rapidly, and any of these services could be equivalently used, if desired.

In some embodiments, SGE 110 deploys an LLM, GAN, or similar AI model 113 for automatically generating summaries based on video content 105, the active user profile, similar user profiles, a viewing history, social media, traditional media, or other relevant data points. AI model 113 may be trained using a dataset that includes data such as the timed text (e.g., subtitles or captions) associated with video content 105, as supplemented with data obtained from various data sources 104. Data sources 104 can include web-based sources, closed loop sources, private sources, social media sources, or third-party data sources. Additional data could include the title of the program, program genre, program characteristics, the names of actors and actresses appearing in the program, professional or amateur reviews or commentary, awards won by the program, and any other information useful in generating summaries. Additional data can also include playback interaction data and timestamps including rewind, seek, scan, playback, playback speed, pause, resume, skip, or other playback interaction data indicating what a user or a group of users has done when watching content. The inclusion of external web data can enhance the model's comprehension and contextual relevance, making it more effective in understanding and interacting with the content. Further, the use of additional data can be particularly helpful when there are gaps in the primary training dataset or when more diverse inputs are required to enhance the model's accuracy and effectiveness. As noted above, any received data can be provided to AI model 113 to generate sets of vectors that can be stored for use in subsequent analysis, including responses to natural language queries.

The architecture of AI model 113 can be designed to be flexible and to adapt to one or more existing frameworks if desired. These frameworks provide the foundational structure and learning algorithms for the LLM, GAN, or other AI model and may also provide resources for “training” custom models by converting input data to mathematical vectors or the like. Frameworks such as LLAMA from Meta Corporation, ChatGPT from OpenAI, and BARD from Google Inc. could be used, for example, to provide just a few examples of the many different frameworks that could be equivalently used. Custom-built AI frameworks could also be employed that are tailored to specific needs or objectives. Each of these frameworks has its unique strengths and methodologies, making them suitable for different aspects of language processing and learning.

In various embodiments, a natural language processing (NLP) module 115 allows for natural language queries to be placed to AI model 113 to generate summaries based upon relevant information. In some embodiments, scene summaries can be generated using prompts including additional reference to a particular viewer’s attributes (e.g., prompts could be tailored based upon gender, geographic location, age, viewing history, genre preference, time constraints, or any number of other factors). Still further embodiments could generate different summaries based upon the viewer’s playback point in the program, thereby offering scene summaries. Again, prompts in an LLM-based example can be tailored as desired so that resulting summaries are specific to the program, as well as the viewer and the viewing position in the program.

AI model 113 and/or network AI service 102 process summary requests in any manner to produce the scene summaries. In various embodiments, the AI engine provides a framework for parsing the natural language query and for searching the vector space of generated vectors to arrive at suitable results. Other AI engines and implementations could operate in any other manner, using any sort of mathematical, statistical, data processing and/or other features to implement the AI model. Results can be digitally returned in response to the received queries via a network, via an inter-process or bus communication within data processing system SGE 110, or in any other manner. In some examples, SGE 110 can receive text-based summaries that describe scenes of particular relevance to the viewer.

Generated summaries and the like may be provided to the viewer devices 140A-B in any manner. In one example, media client applications 144 executed by viewer devices 140A-B communicate with the content management system 124 to provide digital updates about the viewing experience, including content requested, content viewed, viewing habits, viewing duration, and/or the like. Content management system 124 may also be involved with ad replacement or tracking, or other viewer experiences as desired. An example of a content management system that is used to track ad viewing within an adaptive media streaming environment is described in US Patent No. 11,463,785 (incorporated herein by reference), although other types of content management systems could be used in other embodiments. Such systems could be modified to distribute scene summaries and other data along with content.

In one example, content management system 124 obtains scene summaries based on the currently-viewed program and current user profile from SGE 110 and/or database 114. Received scene summaries can then be forwarded to the viewer devices 140A-B. Summaries can be sent along with timed text data or viewing content in some embodiments. Alternatively, viewer devices 140A-B may communicate with SGE 110 or database 114 via API 112 to generate summaries locally. Scene summaries may be presented to the viewer visually on a display or audibly through speakers, and can be accepted or automatically triggered. In some embodiments, summaries can be retrieved, modified, or otherwise interacted with via API 112 for storage in database 114 or further processing.

In various embodiments, scene summaries can be presented in a visual interface that includes currently-playing content or selectable content along with summary data. The presentation can include text-based summaries, audio-based summaries, or combinations of text and audio summaries. Various embodiments could alternately present the scene summaries, for example, as an overlay on the rendered video imagery. A presentation window could be presented in a window that is side-by-side with rendered imagery, for example. Still other embodiments could provide the automatically-generated summaries in a completely separate window, if desired. Even further, summaries could be presented on a separate device such as, for example, a smartphone or tablet. If a viewer is enjoying program content 105 on a television screen, for example, automatically-generated video recap or scene flag could be presented via a notification, text message, or companion application, and viewable on the viewer’s smartphone, tablet, or other device. Timing may be coordinated between the two devices by sharing PTS or other playback timing data (e.g., via CMS 124) from the playback of the media program, thereby ensuring that summaries are presented to the second device until the relevant playback point in content 105 has been reached (e.g., the at a playback point where the scene summary includes only past information.). Other embodiments may be formulated to permit convenient media playback and presentation of summaries.

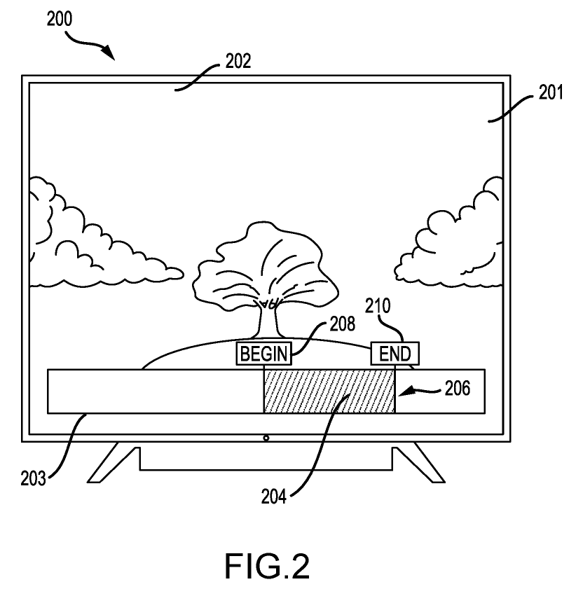

Referring now to FIG. 2, an example of an interface 200 is shown on display 202, in accordance with various embodiments. In various examples, the display 202 may be part of a viewing device (e.g., viewing devices 104A-B, described with respect to FIG. 1). Elements of the interface 200 may be configured and/or presented by the system 100 and/or a similar system. Interface 200 can comprise a search screen 201 in the example of FIG. 2. Interface 200 includes a scrubber 203 with a current position indicator 206, which indicates the current playback position of content in its playback timeline. Interface 200 can include paused content in the background. A time-based summary window 204 can be overlaid on or around a seek bar, track slider, scrub bar, video timeline, or other visual representation of a time-based position in playback of the video, similar to interface 200 of FIG. 2. Summary window 204 can comprise a begin time 208 and an end time 210.

In some embodiments, begin time 208 and end time 210 can be automatically set to a default value. For example, end time 210 can be set to the current playback time as indicated by position indicator 206, and start time 208 can automatically be set to a default of current position less 5 minutes, 10 minutes, 20, minutes, or any other amount of time. In some examples, the summary window can have a being time 208 set to the playback time of the earliest content still stored in the playback buffer, and an end time 210 set to the current playback position. In some embodiments, users can specify the start time 208 of summary window 204 in a query. For example, a viewer can submit a voice query requesting a scene summary from beginning of the content being viewed to present. In response, a playback device could set start time 208 to 0:00 on scrubber 203, or to a time where playback of the actual content begins after previews or advertisements.

Playback devices 140A-B can be configured to pull information regarding scrubber 203. For example, playback devices can retrieve start time 208, end time 210, and other data regarding summary window 204. Summary window 204 may be compared with other data (e.g., pause times, rewind times, fast forward times) to identify locations in playback that a user skipped or perhaps had trouble following the program. System 100 can then take as input data associated with summary window 204. In some examples, summary window 204 can be automatically extend to a scene change location in playback.

For example, start time 208 of summary window 204 can be set to a default value at 23:00 during playback. System 100 can detect the nearest scene change occurring before start time 208 occurs at 20:30 on the playback timeline. System 100 can then adjust start time 208 of summary window 204 to the playback time of 20:30 to match the time of the previously identified scene change. In other embodiments, system 100 can shorten the summary window 204 by moving it to a playback time of a scene change forward in the playback timeline. Start time 208 can be moved forward in response to a scene change being within a threshold period forward of start time 208. For example, start time 208 set to 23:00 can be moved to 23:15 in response to a scene change occurring within a predetermined period of the 23:00 start time. In some examples, the predetermined period can be within 5 seconds, within 10 seconds, within 15 seconds, within 30 seconds, within 1 minute, or within any desired period of start time 208. System 100 can summarize the dialogue and activity occurring within the summary window 204 of the current program to generate a scene summary.

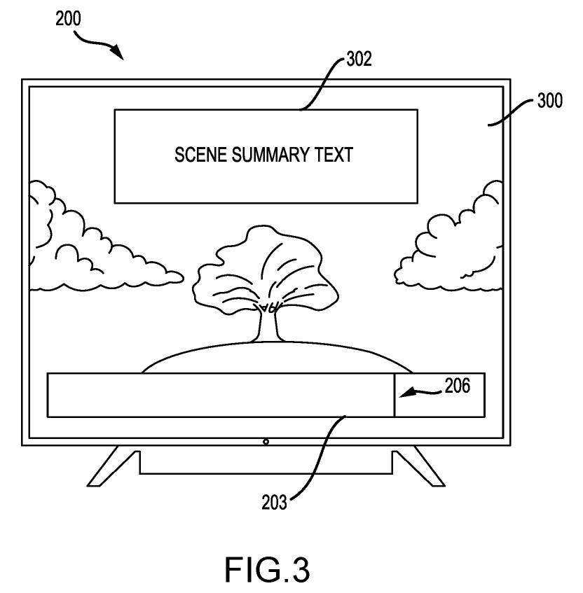

Referring to FIG. 3, a subsequent screen 300 of interface 200 is shown, in accordance with various embodiments. Screen 300 can include a simplified scrubber 303, though the scrubber 203 with overlaid search information can be maintained in some embodiments. In various examples, scrubber 303 can comprise visual elements and production techniques similar to or the same as those of scrubber 203 and position indicator 206. In other examples, scrubber 303 can be completely omitted, with scene summary windowing occurring in the background. Screen 300 can maintain paused content in the background, with position indicator 206 maintained at the current playback position. In some embodiments, the viewer can hit play to cancel the scene summary request and resume playback.

Scene summary text can be presented in text box 302. In the example of FIG. 3, text box 302 is shown as overlaid on paused content for example purposes, though text-based scene summaries can be delivered without a window, on a separate device, over a plain screen, or in any other suitable manner. Some examples can deliver a scene summary using audible words by using a text to speech conversion, and such examples can omit on-screen text delivery.

SGE 110 can process scenes and related data within summary window 204 of the playback timeline. Time stamped data such as, for example, closed captioning can be a reliable source for dialogue and action occurring at particular times during playback, including within summary window 204. In text-based examples, SGE 110 can save timestamps or time ranges of content used to generate each sentence, clause, or portion of the summary. Links can be generated for sentences, clauses, or portion of the summary that immediately begin playback at the earliest associated timestamp of the underlying content that was summarized in the sentence, clause, or portion of the summary. The resulting summary can include one or more the sentences, clauses, or portions. Text of the summary can be ordered based on associated playback times of the underlying content being summarized.

A scene summary can include a sentence of the scene summary presented in text box 302 can relate to dialogue in a scene lasting from 12:36 to 13:45. SGE 110 can save the window from 12:36 to 13:45 in association with the sentence of the scene summary. SGE 110 can link the sentence to the relevant content, starting at 12:36 and lasting until 13:45. In the example of FIG. 3, the sentence presented in text box 302 includes the sentence, and the sentence is selectable and clickable. In response to selection of the sentence and execution of the link, playback can automatically begin at 12:36 and terminate at 13:45. After playback of the linked content, the playback indicator can be returned to its original position in the paused content. Resuming playback can begin playback at the point where the viewer paused playback or submitted a scene summary request.

In some embodiments, the scenes underlying the scene summary can be played back in response to a user input requesting playback. For example, text box 302 can include a “play all” button that triggers playback of the content underlying the summary. Playback of different sections can be in chronological order, logical order, based on the order in which content is summarized in the text, or in any other order using timestamps to affect playback of the summarized content. After playback of the linked content, the playback indicator can be returned to its original position in the paused content. Resuming playback can begin playback at the point where the viewer paused playback or submitted a scene summary request.

In some examples, content can be pre-summarized into text or audible words, and the scene summaries can be stored in association with the content. Summarized dialogue and action can be stored in text in sentences, clauses, or other atomic units of text in association with time stamps of the content summarized in each atomic unit. Text or voice scene summaries can be retrieved based on the timestamps of the underlying summarized content being within summary window 204. Summary text or audio delivered to the user can be adapted in real time in response to modification of summary window 204. Portions of summary can be selected for presentation based on associated timestamps being within or overlapping with summary window 204.

Preprocessing can enable faster summary delivery in some examples. Preprocessing can further simplify summaries for television series or movies spanning multiple episodes or sequels and originals, respectively. In such embodiments, summary window 204 can span earlier episodes or earlier originals or sequels that come before the presently viewed content in a storytelling order. For example, a viewer can be watching “Avengers: Infinity War” and request a scene summary. The summary window can span “The Avengers” and “Avengers: Age of Ultron,” both coming before the currently viewed content. The resulting summary can include text summaries of content relevant to the currently viewed scenes from the earlier two movie installments in the series. The interfaces depicted in FIGS. 2 and 3 show non-limiting example techniques for delivering scene summaries. Other techniques can be used to deliver scene summaries without deviating from the present disclosure.

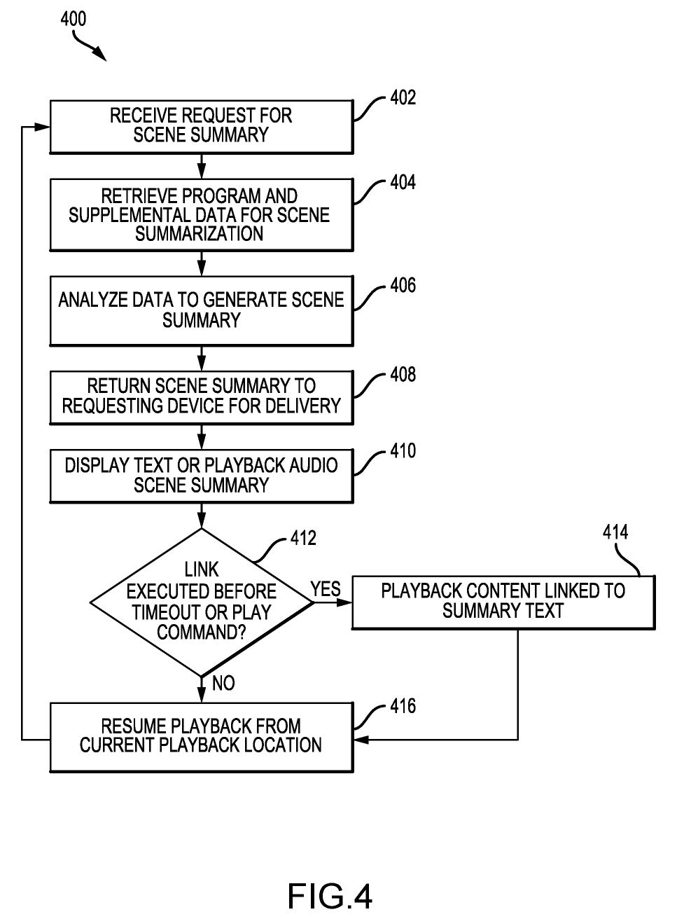

With reference to FIG. 4, an example process 400 is shown for machine generation and delivery of scene summaries in a media viewing system, in accordance with various embodiments. The various functions of process 400 may be performed using processor 117 executing software, firmware or other programmable logic, as augmented by the other components of system 100. Other embodiments may divide processing between the various components of system 100, including viewer devices 140A-B, as desired. In some implementations, a media application 144 could contain an AI model or other construct that has been trained on various user data and media programs so that some or all scene summary generation is handled locally on devices 140A-B, thereby reducing processing demands on SGE 110. In this example, media application 144 could interact with SGE 110 or another AI service 102 to supplement the local processing capability. In a further embodiment, an AI executing locally on viewer device 140A obtains initial content summaries from SGE 110 or AI service 102 but aggregates into presentable scene summaries using a locally-executed model. To that end, whole or partial scene summaries generated by AI elements executing on viewer device 140, SGE 110, and networked AI services 102 could be combined in any manner.

In various embodiments, automated process 400 may include receiving a request for a scene summary (Block 402). The request can be triggered by any component of system 100 or other remote computing devices. In some embodiments, content management system 124 receives a request from user device 140A and formats a query for SGE 110. In some examples, SGE 110 can receive the request from content management system 124, from a viewer device 140A-B, or from another computing device. For example, a remote control can be used by a viewer to submit a voice-request for a scene summary. AI service 102 can also receive the request in some examples. The request can be received in response to user pausing or rewinding a media program. The request can also be received in response to user submission using voice, text, or a physical or digital button configured to request a scene summary.

In response to the request for a summary, or in advance of the request in some embodiments, system 100 may retrieve program and supplemental data (Block 404). Some embodiments can generate summaries using only closed captioning data or other time-synced data. Program data can also include metadata describing the program or scenes to be summarized. Metadata describing the program or program data may include portions of the program itself (e.g., timed text), closed captioning data, program guide data, media relating to the program, playback data, feedback data from system 100, user interaction data, critical reception of the program, scripts, text summaries, social media tagging, or other information relating to the program, in addition to or as an alternative to other information about the media program that is available from other data sources 104. Viewer data can include viewer demographics, viewing history, viewer preferences, account settings, or other data relating to or describing the viewer. The viewer data can be associated with the playback device, for example, through an account logged in to the playback device or authenticated with the broader content delivery system.

In various embodiments, an AI model can analyze the program data and viewer data to generate a scene summary (Block 406). In some examples, the summary may be generated analyzing program data without viewer data. In one example, a scene summary can be generated by considering playback data for all users to identify important segments, oft replayed segments, or segments otherwise identified as difficult-to-follow within the content within summary window 204. In yet another example, a scene summary can be generated by considering playback data for users of a selected demographic group to identify important segments, oft replayed segments, or segments otherwise identified as difficult-to-follow within content. In another example, flags can be generated based on relevance of scenes to future scenes in the same episode or movie, in future episodes, or in sequels. In a sports example, flags can be generated to identify scoring moments, penalties, celebrations, races, finishes, tournaments, highlights for a selected player, or other moments of interest in broadcasts or recordings of sporting events. AI model 113, AI service 102, or an AI model local to user device 140A can be variously used to analyze the program data and applicable user data.

System 100 can return the scene summary to requesting device for delivery (Block 408). The scene summary text, audio, or links can be returned to the requesting component of system 100 or other remote computing devices in communication with system 100.

In some implementations, process 400 may be executed in real-time or near real-time, recognizing some delays inherent in data processing, digital communications, and the like. That is, machine-generated scene summaries can be created in real time in response to a request made during playback of the current content, a request from the viewer, the viewer browsing pausing or rewinding the content, content management system 124 making new content available, broadcast of live content, recording of content beginning, or other triggers. This would permit highly customized summaries to be generated based upon the viewer’s attributes, viewing history, and the like, particularly with embodiments that preprocess content to generate summary components. Such embodiments could permit summaries to be generated prior to presentation, with the atomic components of scene summaries being stored (e.g., in database 114) until an appropriate time for aggregation and presentation to the viewer. Still other embodiments could combine these approaches by permitting some more generic portions of scene summaries to be generated in advance, with additional tailored portions of scene summaries or refinements generated in response to the viewer’s real time behavior or characteristics.

As noted above, program content 105 may be processed in any manner. In various embodiments, viewer device 140A identifies a program of interest via content management system 124. The program could be a recently added program, for example, or a program in a viewer’s playlist, or the like. In some embodiments, certain content 105 may be selected for analysis even before the particular viewer selects the program to improve response times. Continuing the LLM-based example, the LLM can be trained on metadata describing the program content, viewers, and their viewing habits, and default summaries can be generated for storage and subsequent use in association with the pre-processed program. In some embodiments, viewing histories can be stored and used for training and analysis. Preprocessing can result in atomic elements of summary text and associated playback timestamps and links to underlying content. Stored elements can be retrieved using the playback timestamps in response to a user requesting a summary of content within summary window 204.

AI 113 may be trained based upon dialog and scene changes of the program, for example, to learn about the program content and to determine timing information so that the various scenes in the program can be referenced in a scene summary. AI can attempt to generate a sentence, clause, or other atomic component of summary text for each complete scene. Other information about content 105 may be used to train AI 113 so that further context or detail can be learned. Other information could include any sort of information from public or private databases, as noted above, as well as any external AI services that may be available, as desired. Training the AI could involve any process or technique by which AI 113 becomes aware of the input data. As noted above, the AI may provide a framework or ingestion engine that receives input data that is then converted to mathematical vectors or the like for storage and subsequent processing. Data may be tagged, if desired, to permit more efficient recognition and conversion to digital format. Other embodiments may intake and analyze the received data in any other way.

In various embodiments, the scene summaries can be obtained from AI model 113 (or AI service 102) by placing a natural language query in the system using LLM or similar language-based AI models. SGE 110 or application 144 may include NLP module 115 for formatting natural language queries that can produce useful results from the trained AI 113. As noted above, queries may consider the viewer’s demographic information, viewing history or preferences, past engagement with scene summaries, or the like in generating specific queries to the AI 113. Formatted queries can be provided to any trained AI model to receive machine-generated results. Queries can be placed to AI 113 or the like that has been trained on the specific content 105, for example, to obtain customized results.

Various embodiments may posit queries to both a local AI model 113 and to a network AI service 102 to obtain additional information, for redundancy, or for any other purpose. Queries may be simultaneously submitted, if desired, or queries may be staggered so that one service provides different information (e.g., “filling in the gaps”) than the information received from the other service. Again, functions could be shared or intermixed between local and remote AI engines 113 and 102, respectively, in any manner. For example, it may not be necessary to train AI 113 on every content 105. Some commercially available AI services 102 may already be trained on certain media content 105 (e.g., more popular movies), for example, so those services could be queried as appropriate for information that is within their knowledge base, without the need to duplicate that knowledge locally. Still further embodiments could obtain a “first draft” of summary materials from an external AI service 102, with a locally-executing AI 113 providing more detailed context, as well as an added layer of viewer anonymity, if desired. Other hybrid scenarios could be formulated to use local or remote AI resources in any manner.

In various embodiments, system 100 may display text or playback audio of scene summaries (Block 410). The machine-generated scene summary may be presented to the user while playback is paused in some examples. In some examples, the scene summaries can include links to underlying content in the currently viewed program, as described above.

System 100 may check whether a link of the scene summary has been executed before a timeout or a play command (Block 412). A timeout duration can be set for the viewer’s user account. Example timeout durations can be 15 seconds, 30 seconds, 1 minute, 3 minutes, 5 minutes, or any desired duration. User account settings may be stored locally on user device 140A, by content management system 124, in database 114, or in other computing systems communicating with system 100 over a network. If links are not used before the timeout expires, playback can resume.

In response to a viewer executing a link in a playback summary, system 100 can playback the content linked to the selected summary text (Block 414). System 100 can playback linked content by moving the current play position to the beginning timestamp associated with the summarized text and link. Once playback is complete, playback of the next link can begin automatically in some embodiments. In some examples, once playback is complete, the current playback position is returned to the original playback position before the playback link was executed. Links and playback timestamps associated with summary text can be stored in database 114, on viewer device 140A, on content management system 124, or on other computing devices of or in communication with system 100. The links may be presented to the viewer making text of the summary executable to follow the playback link. Links can also be delivered to a viewer via secondary delivery channels such as, for example, email, text messaging, or any other technique for delivering text. Executing a link through a secondary source can cause playback of the linked text on the active viewing device 140A presently in use. For example, the summary can be selected and presented over the current content in response to a request for a scene summary. The summary can be presented as a selectable button overlay that triggers playback of all summarized content, or of single portions of content that underly individual atomic portions of the scene summaries.

Automatically-generated scene summaries can be provided to the viewer in any manner. If the summaries are generated locally on viewer device 140A-B, for example, summaries could be provided on a display via an interface as discussed above. If the summaries are generated by SGE 110, the results could be provided to the viewer’s device 140A and/or to a companion device also associated with the viewer via content management system 124 or API 112. In one example, API 112 provides a secure hypertext transport protocol (HTTP) interface that interacts with client application 144 to request and receive machine-generated scene summaries, although other embodiments could transfer the materials in other ways.

In various embodiments, AI 113 or AI service 102 can analyze past scene summaries for the viewing user or similar users in generating new summaries for the viewing user. System 100 can thus avoid making the same types of summaries including the same type of scenes in video links for content that the viewer does not completely view or skips, for example.

Playback can resume from the current playback location (Block 412). Playback can resume in response to the summary being displayed for a timeout duration based on user settings or default values until the timeout duration has passed. Playback can resume in response to a user hitting play. Playback can resume in response to all links being played. In some examples, playback can resume at a different location in response to a user selecting a different location in scrubber 203. Playback can continue until the end of the video content is reached, until a user stops playback, or until another request is received from the user for a scene summery.

Systems, methods, and devices of the present disclosure can abbreviate or improve consumption of media by summarizing scenes or related content. Summaries can summarize previous portions of the video content within a summary window, can include web-based content that answers questions about a scene within the summary window, and can help users navigate replay of earlier content to improve understanding. Viewers may thus avoid internet searching, rewinding, reviewing, or continuing with unanswered questions by requesting a scene summary. Viewers can navigate replays of program segments underlying the scene summaries by interacting with links in the scene summaries.

Benefits, other advantages, and solutions to problems have been described herein with regard to specific embodiments. Furthermore, the connecting lines shown in the various figures contained herein are intended to represent example functional relationships or couplings between the various elements. It should be noted that many alternative or additional functional relationships or connections may be present in a practical system. However, the benefits, advantages, solutions to problems, and any elements that may cause any benefit, advantage, or solution to occur or become more pronounced are not to be construed as critical, required, or essential features or elements of the inventions.

The scope of the invention is accordingly to be limited by nothing other than the appended claims, in which reference to an element in the singular is not intended to mean “one and only one” unless explicitly so stated, but rather “one or more.” Moreover, where a phrase similar to “A, B, or C” is used herein, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or device that comprises a list of elements does not include only those elements but may include other elements not expressly listed or inherent to such process, method, article, or device.

The term “exemplary” is used herein to represent one example, instance, or illustration that may have any number of alternates. Any implementation described herein as “exemplary” should not necessarily be construed as preferred or advantageous over other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents.

What is claimed is:

1. An automated process for generating scene summaries, the automated process comprising:
retrieving program data related to currently playing content at a playback device and pausing the currently playing content in response to a request for a scene summary, wherein the program data includes program text with associated playback timestamps;
identifying a summary window of the currently playing content, the summary window comprising a begin time and an end time, wherein the summary window is identified at least in part based on the playback timestamps;
analyzing a subset of the program data having the associated timestamps at least partially in the summary window, wherein an artificial intelligence (AI) model generates the scene summary related to the currently playing content based on the subset of the program data; and
overlaying the scene summary of the currently playing content over the currently playing content at the playback device.

2. The automated process of claim 1, wherein a portion of the scene summary comprises a link to portions of the currently playing program used to generate the portion of the scene summary.

3. The automated process of claim 2, further comprising playing back the portions of the currently playing program in response to receiving a command executing the link.

4. The automated process of claim 1, further comprising presenting the scene summary to a viewer through a text-based message or an email on a secondary device.

5. The automated process of claim 1, wherein the scene summary comprises data retrieved from a website in response to the request for the scene summary inquiring for analysis of a scene.

6. The automated process of claim 1, further comprising resuming playback in response to a timeout duration passing while the scene summary is overlaid on the currently playing program.

7. The automated process of claim 1, further comprising converting the request for the scene summary from voice to text.

8. The automated process of claim 1, wherein the AI model generates the scene summary at least partially based on demographic data of a viewer associated with the playback device.

9. A playback device comprising a processor in communication with a non-transitory memory configured to store instructions thereon that, when executed by the processor, cause the playback device to perform operations, the operations comprising:
retrieving program data related to currently playing content and pausing the currently playing content in response to a request for a scene summary, wherein the program data includes program text with associated playback timestamps;
identifying a summary window of the currently playing content, the summary window comprising a begin time and an end time, wherein the summary window is identified at least in part based on the playback timestamps;
analyzing a subset of the program data having the associated timestamps at least partially in the summary window, wherein an artificial intelligence (AI) model generates the scene summary related to the currently playing content based on the subset of the program data; and
overlaying the scene summary of the currently playing content over the currently playing content.

10. The playback device of claim 9, wherein a portion of the scene summary comprises a link to portions of the currently playing program used to generate the portion of the scene summary.

11. The playback device of claim 10, wherein the operations further comprise playing back the portions of the currently playing program in response to receiving a command executing the link.

12. The playback device of claim 9, wherein the operations further comprise analyzing the currently playing content between the start time and the end time using visual recognition to identify a character for the scene summary.

13. The playback device of claim 9, wherein the operations further comprise analyzing an audio of the currently playing content between the start time and the end time to identify a scene of interest for the scene summary.

14. The playback device of claim 9, wherein the operations further comprise converting the request for the scene summary from voice to text.

15. The playback device of claim 14, wherein the operations further comprise reformatting the converted request for the scene summary to include the begin time of the summary window and the end time of the summary window.

16. A non-tangible computer-readable medium configured to store instructions thereon that, when executed by a computer-based system, causes the computer-based system to perform operations, the operations comprising:
retrieving program data related to currently playing content in response to a request for a scene summary, wherein the program data includes program text with associated playback timestamps;
identifying a summary window of the currently playing content, the summary window defined at least in part based on the playback timestamps and comprising a begin time and an end time;
analyzing a subset of the program data having the associated timestamps at least partially in the summary window, wherein an artificial intelligence (AI) model generates the scene summary related to the currently playing content based on the subset of the program data; and
outputting the scene summary of the currently playing content in response to the request for the scene summary.

17. The non-tangible computer-readable medium of claim 16, wherein a portion of the scene summary comprises a link to portions of the currently playing program used to generate the portion of the scene summary.

18. The non-tangible computer-readable medium of claim 17, wherein a playback device resumes playback of the currently playing content in response to a timeout duration passing while displaying the scene summary.

19. The non-tangible computer-readable medium of claim 17, wherein the operations further comprise converting the request for the scene summary from voice to text.

20. The non-tangible computer-readable medium of claim 19, further comprising reformatting the converted request for the scene summary to include the begin time of the summary window and the end time of the summary window for submission to a large language model.
